(19) United States
(12) Patent Application Publication
(10) Pub. No.: US 2025/0245007 A1
(43) Pub. Date: Jul. 31, 2025

(54) HARDWARE ACCELERATION FOR PIPELINED FLOATING POINT OPERATIONS

(71) Applicant: Texas Instruments Incorporated, Dallas, TX (US)

(72) Inventors: Garrett Lies, Dallas, TX (US); Duc Bui, Grand Prairie, TX (US); Donald E. Steiss, Richardson, TX (US)

(21) Appl. No.: 18/427,546

(22) Filed: Jan. 30, 2024

(51) Int. Cl. G06F 9/30

(52) U.S. Cl. CPC G06F 9/30036; G06F 9/30032

(57) ABSTRACT

In described examples, an integrated circuit (IC) includes a comparator, a shift calculator, an aligner, a compressor, and an adder. The comparator determines a largest one of multiple exponents. The shift calculator subtract the exponents from the determined largest exponent to provide a set of shift values. The aligner shifts a subset of a set of data values in a least significant bit direction responsive to respective ones of the shift values to generate a first number of aligned data values. The compressor generates a second number of compressed data values responsive to the first number of aligned data values. The second number is less than the first number. An adder sums the compressed data values.

### TECHNICAL FIELD

This application relates generally to pipelined floating point operations, and more particularly to hardware acceleration for pipelined floating point operations on multiple operands.

### BACKGROUND

Various applications use floating point operations performed on three or more operands at a time. For example, convolution layers of neural networks can be processed using floating point operations, such as matrix multiply-accumulate (MMA) operations, applied to matrices corresponding to feature maps and filter kernels. Various forms of statistical analysis can also be broken down into operations that process large numbers of operands together. Accordingly, increased efficiency of floating point operations can be used to improve system efficiency and response rate.

### SUMMARY

In described examples, an integrated circuit (IC) includes a comparator, a shift calculator, an aligner, a compressor, and an adder. The comparator determines a largest one of multiple exponents. The shift calculator subtracts the exponents from the determined largest exponent to provide a set of shift values. The aligner shifts a subset of a set of data values in a least significant bit direction responsive to respective ones of the shift values to generate a first number of aligned data values. The compressor generates a second number of compressed data values responsive to the first number of aligned data values. The second number is less than the first number. An adder sums the compressed data values.

### BRIEF DESCRIPTION OF THE DRAWINGS

FIG. 1 is a functional block diagram of an example integrated circuit that includes a hardware MMA acceleration pipeline for a floating point MMA operation.

FIG. 2A is a functional block diagram of a first example hardware MMA acceleration pipeline for a floating point MMA operation of FIG. 1.

FIG. 2B is a functional block diagram of a second example hardware MMA acceleration pipeline for a floating point MMA operation of FIG. 1.

FIG. 2C is a functional block diagram of a third example hardware MMA acceleration pipeline for a floating point MMA operation of FIG. 1.

FIG. 3 is a functional block diagram of an example hardware exponent arithmetic unit of FIG. 2A.

FIG. 4A is a functional block diagram of a first example addition unit that includes the compressor and adder of FIG. 2A.

FIG. 4B is an alternative functional block diagram of the addition unit of FIG. 4A.

FIG. 4C is a functional block diagram of a second example addition unit that includes the compressor and adder of FIG. 2A.

FIG. 4D is a functional block diagram of a third example addition unit that includes the compressor and adder of FIG. 2A.

FIG. 4E is a continuation of the functional block diagram of the third example addition unit of FIG. 4D.

FIG. 5 is a process for determining a dot product between the elements of two vectors of floating point binary numbers.

### DETAILED DESCRIPTION

Neural networks may include layers in which a feature map, corresponding to a set of input data, is convolved with a filter kernel, corresponding to a set of weights. Convolution can use, for example, an inner product function or an outer product function. Inner products can be determined using dot products of input vectors of binary numbers. Dot products can be determined by multiplying elements in a first vector of binary numbers by same-index elements in a second vector of binary numbers, and then summing the resulting products.

In some examples, elements in feature maps and filter kernels are expressed as floating point binary numbers. To determine a dot product of floating point binary numbers, mantissa (fractional) portions of same-index elements of two vectors of numbers are multiplied together. In parallel with this multiplication, a shift amount is determined to enable aligning the product mantissas. The shift amount indicates a rightward (in a least significant bit direction) shift that will make each product mantissa correspond to a same exponent as a largest exponent of the product mantissas. Adding unaligned product mantissas, which accordingly correspond to different exponents, can result in meaningless results.

The product mantissas are aligned in response to the corresponding shift amounts. The aligned product mantissas are compressed using a compressor, and the outputs of the compressor are added together by an adder. A compressor accepts a first number of inputs, and provides a second, smaller number of outputs. (In some examples, different compressors can be used to facilitate addition or multiplication.) The output of the adder is the dot product of the two vectors of floating point binary numbers. Aligning the floating point binary numbers prior to compression and addition enables use of a relatively small, fast, and/or low power compressor and adder.

Herein, some structures or signals that are distinct but related have reference numbers that use a [number][letter] or [number][hyphen][number]format, such as MMA acceleration pipeline 104a, 104b, and 104c, or exponent addition units 304-1, 304-2, . . . , and 304-8. In some examples, these structures or signals are referred to generally, in the singular or as a group, using the [number] and without the [letter] or the [hyphen][number], such as the MMA acceleration pipeline 104 or the exponent addition units 304. Also, the same reference numbers or other reference designators are used in the drawings to designate features that are related structurally and/or functionally.

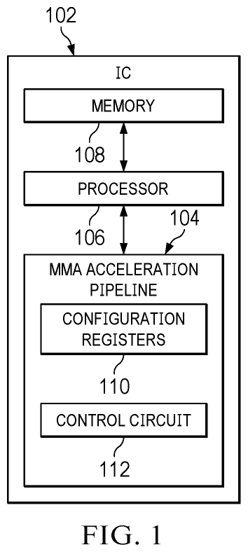

FIG. 1 is a functional block diagram of an example integrated circuit (IC) 102 that includes a hardware MMA acceleration pipeline 104 for a floating point MMA operation. The IC 102 also includes a processor 106 bidirectionally coupled to a memory 108 and the MMA acceleration pipeline 104. The memory 108 includes instructions that the processor 106 executes to control the MMA acceleration pipeline 104. The MMA acceleration pipeline 104 includes one or more configuration registers 110 and a control circuit 112. In some examples, the MMA acceleration pipeline 104 can also be used to perform integer operations, such as by storing configuration data in the configuration registers 110. In response to the configuration data in the configuration registers 110, the control circuit 112 can cause the MMA acceleration pipeline 104 to operate in an integer operations mode. In some examples, the memory 108 stores instructions for execution by the processor 106 to cause the MMA acceleration pipeline 104 to perform floating point MMA or other MMA operations on data values stored in the memory 108.

In some examples, the control circuit 112 can be implemented responsive to one or more finite state machines that control a data path of the MMA acceleration pipeline 104. In some examples, different data paths correspond to different operations that can be performed by the MMA acceleration pipeline 104. In some examples, the control circuit 112 and/or the configuration registers 110 can be implemented as part of the processor 106, or as a separate central processing unit (CPU), digital signal processor (DSP), microcontroller unit (MCU), or other processor.

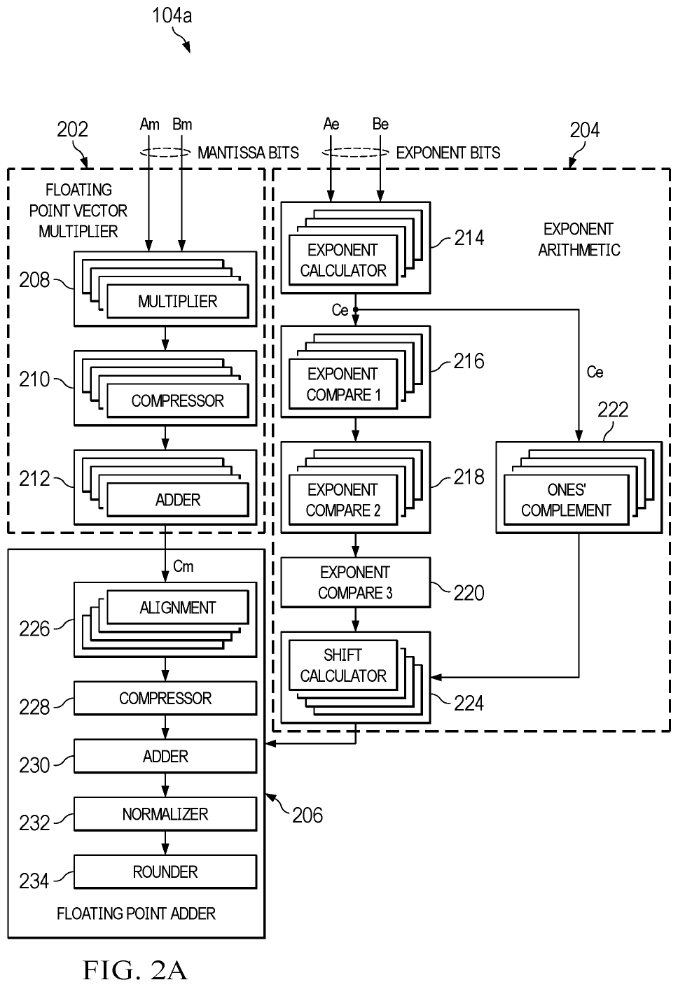

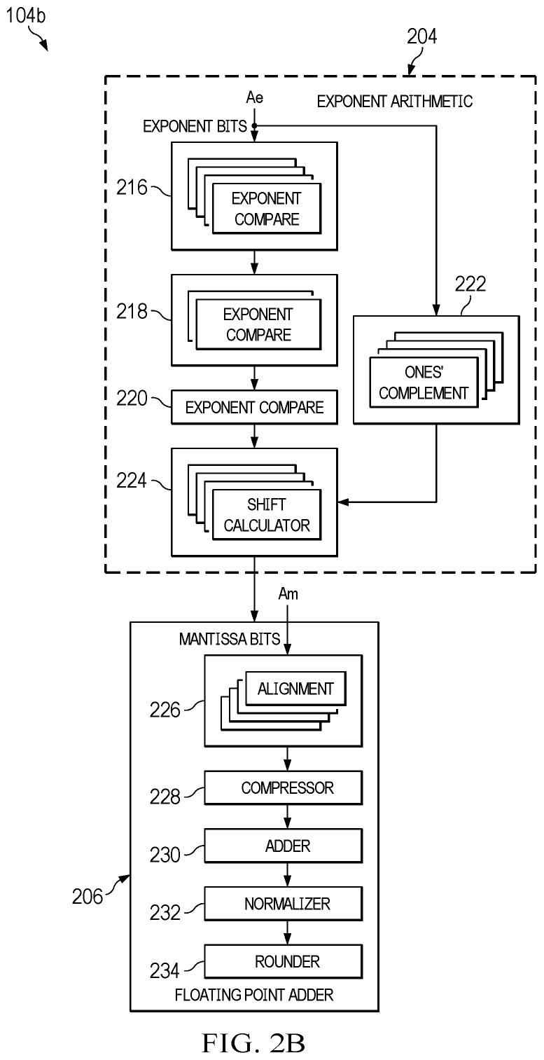

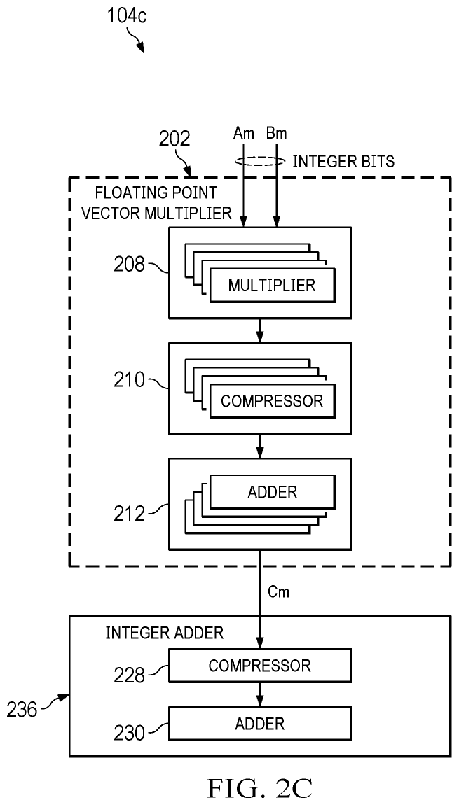

FIG. 2A is a functional block diagram of a first example hardware MMA acceleration pipeline 104a for a floating point MMA operation of FIG. 1. The MMA acceleration pipeline 104 includes a floating point vector multiplier 202, an exponent arithmetic unit 204, and a floating point adder 206. The floating point vector multiplier 202 includes a multiplier block 208, a compressor block 210, and an adder block 212. The exponent arithmetic unit 204 includes an exponent calculator block 214, a first exponent compare stage (exponent compare 1) 216, a second exponent compare stage (exponent compare 2) 218, a third exponent compare stage 220 (exponent compare 3), a ones' complement block 222, and a shift calculator block 224. The floating point adder 206 includes an alignment block 226, a compressor 228, an adder 230, a normalizer 232, and a rounder 234. In some examples, each of 202, 204, and 206 and the elements therein may be implemented as an electronic circuit.

In some examples, the MMA acceleration pipeline 104 determines the dot product of two vectors of binary numbers, A and B. Elements in vectors are represented herein as [name of vector][index], for example, A[1] is the first element of vector A, and B[3] is the third element of vector B. Vector A and vector B each have a number N elements, A[1] through A[N] and B[1] through B[N], respectively. Accordingly, if A and B each have eight elements, then the MMA acceleration pipeline 104 determines A[1]×B[1]+A[2]×B[2]+ . . . +A[8]×B[8]. In some examples, A and B vectors have a different number of elements; handling of additional elements in one of the vectors may be implementation-dependent.

As described above, the first example MMA acceleration pipeline 104 can be used to determine the dot product of two vectors of binary fractions. A second example MMA acceleration pipeline 104b, shown and described with respect to FIG. 2B, can be used to determine the sum of the elements of a vector of binary fractions. A third example MMA acceleration pipeline 104c, shown and described with respect to FIG. 2C, can be used to determine the dot product of two vectors of integers.

An MMA acceleration pipeline 104 may be implemented using hardware, such as a CPU, DSP, MCU, or other processor, and/or using dedicated acceleration circuits. In some examples, such dedicated acceleration circuits correspond to the functional blocks described herein, such as the floating point vector multiplier 202, the exponent arithmetic unit 204, the floating point adder 206, and/or the component blocks thereof, such as the multiplier block 208, the exponent compare stages 216, 218, 220, etc.

The multiplier block 208 of the floating point vector multiplier 202 receives the mantissa bits of a first vector of binary numbers via a first set of input lines (Am), and receives the mantissa bits of a second vector of binary numbers via a second set of input lines (Bm), where in each case the “m” is to indicate mantissas. The mantissas of the elements of vector A will be referred to herein as elements of a vector Am, and the mantissas of the elements of vector B will be referred to herein as elements of a vector Bm. The multiplier block 208 outputs to the compressor block 210. The compressor block 210 outputs to the adder block 212. The adder block 212 outputs to the alignment block 226 of the floating point adder 206.

The floating point vector multiplier 202 determines the products of corresponding elements of vectors Am and Bm. Accordingly, if Am and Bm each have eight elements, the floating point vector multiplier 202 determines products Am[1]×Bm[1], Am[2]×Bm[2], . . . , and Am[8]×Bm[8]. These products are referred to herein as elements of a vector Cm. The elements of vector Cm are mantissas of products of elements of vector A with corresponding elements of vector B.

The exponent calculator block 214 of the exponent arithmetic unit 204 receives the exponent bits of vector A via a third set of input lines (Ae), and receives the exponent bits of vector B via a fourth set of input lines (Be), where in each case the “e” is to indicate exponents. The exponents of the elements of vector A will be referred to herein as elements of a vector Ae, and the exponents of the elements of vector B will be referred to herein as elements of a vector Be. The exponent arithmetic unit 204 first determines a vector of exponents Ce, so that elements of Ce, together with corresponding elements of Cm (from the output of the floating point vector multiplier 202), represent the element-by-element products of vectors A and B. Vector Ce, concatenated element-by-element with vector Cm, forms a vector C of the element-by-element products of vectors A and B. The MMA hardware accelerator 104 can be described as determining the sum of the elements of vector C.

The exponent arithmetic unit 204 determines an element of Cm corresponding to a largest exponent, accordingly, a largest element of Ce. The exponent arithmetic unit 204 then determines by how many bits to right-shift the other elements of Cm (representing the most significant bit (MSB) on the left) so that all of the elements of Cm correspond to the same, largest exponent. In some examples, the exponent arithmetic unit 204 operates in parallel with the floating point vector multiplier 202.

The exponent calculator block 214 outputs to the first exponent compare stage 216 and to the ones' complement block 222. The first exponent compare stage 216 outputs to the second exponent compare stage 218, which outputs to the third exponent compare stage 220. The ones' complement block 222 and the third exponent compare stage 220 each output to the shift calculator block 224. The shift calculator block 224 outputs to the alignment block 226 of the floating point adder 206.

The alignment block 226 of the floating point adder 206 receives the respective outputs of the adder block 212 and the shift calculator block 224 and outputs to the compressor 228. The compressor 228 outputs to the adder 230, which outputs to the normalizer 232. The normalizer 232 provides the output of the MMA acceleration pipeline 104.

The floating point vector multiplier 202 multiplies mantissas of corresponding pairs of an element (number) of vector A and an element of vector B. As described above, the multiplier block 208 receives the mantissa bits of vector A via a first set of input lines (Am), and receives the mantissa bits of vector B via a second set of input lines (Bm).

The number of mantissa bits in each set of input lines can be configured using the configuration registers 110 and the control circuit 112 to correspond to a floating point data type. For example, the Institute of Electrical and Electronics Engineers (IEEE) 754 standard includes a first single-precision floating point format (in some examples, also called float32) which includes a sign bit, eight exponent bits, and 23 mantissa bits, and a second floating point format (bfloat16) with one sign bit, eight exponent bits, and seven mantissa bits, with an implicit (not stored) leading eighth mantissa bit that equals one for non-zero numbers. In some examples, a float32 number can be converted to bfloat16 by truncation of the mantissa of the float32 number.

The multiplier block 208 includes multiple multiplier units. In an example, the multiplier block 208 is designed to multiply respective pairs of elements of two vectors of N elements and thus includes N multiplier units. (Pairs of elements correspond to an element from a first vector and an element from a second vector.) Each multiplier unit multiplies two binary numbers (such as mantissas or integers) to produce multiple binary number partial products as outputs. The multiplier block 208 provides these partial products to the compressor block 210. In some examples, radix-8 Booth encoding or radix-4 Booth encoding can be used by the multiplier block 208 in performing multiplication. Other types of multiplier can also be used.

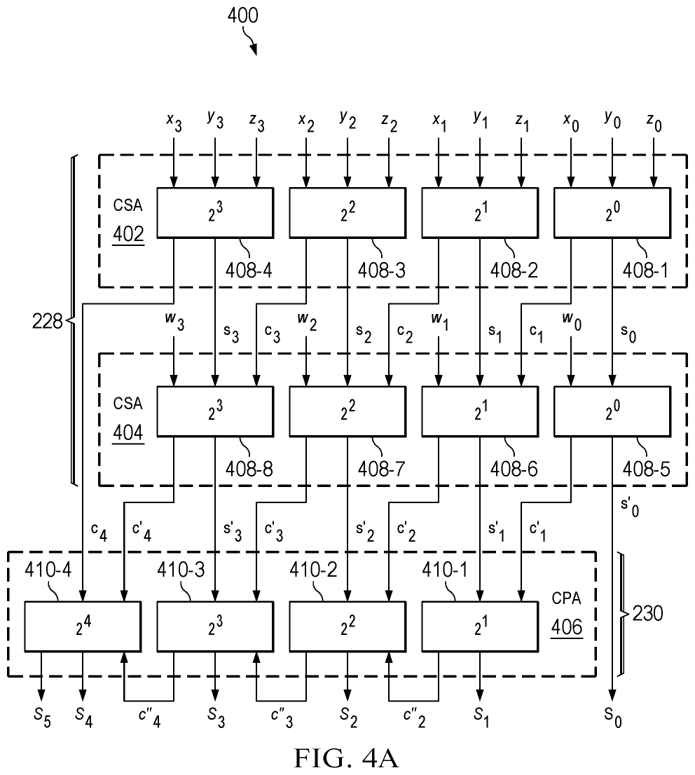

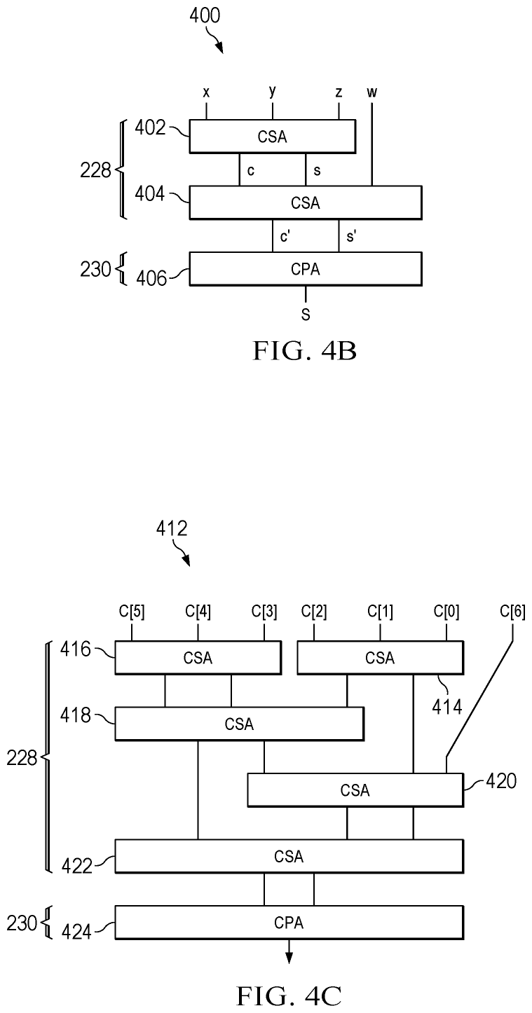

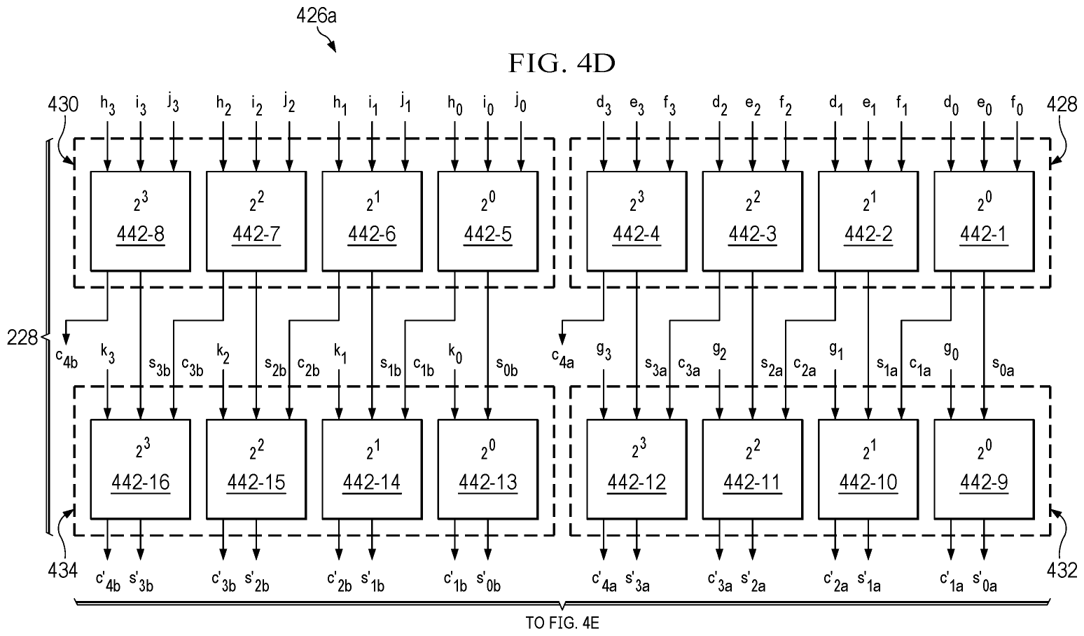

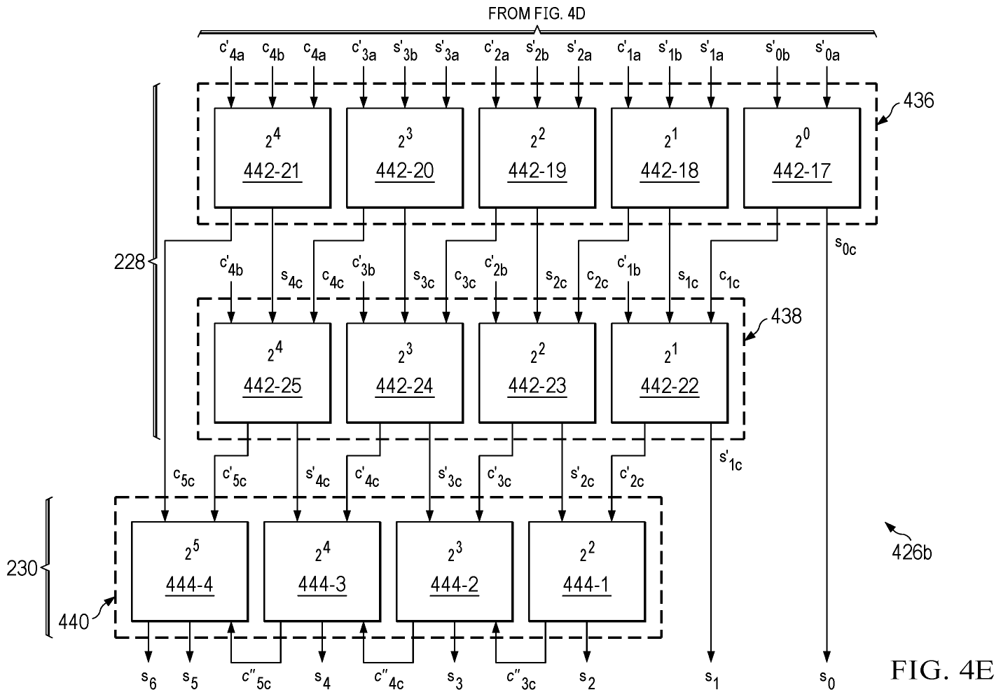

The compressor block 210 includes multiple compressor units. Each compressor unit combines a set of partial products corresponding to a respective pair of numbers multiplied by the multiplier block 208 to produce two outputs, which are provided by the compressor block 210 to the adder block 212. Compression is further described below with respect to the floating point adder 206, and with respect to FIGS. 4A, 4B, and 4C.

The adder block 212 includes multiple adder units. In some examples, the number of adder units of the adder block 212 is the same as the number of compressor units of the compressor block 210. Each adder unit adds together a pair of outputs of a corresponding compressor unit of the compressor block 210 to generate an output of the floating point vector multiplier 202, accordingly, an element of vector Cm. In an example, the compressor bock 210 is or includes one or more carry-save adder (CSA) trees, and the adder block 212 is or includes one or more carry-propagate adders (CPAs, also called ripple-carry adders).

As described above, the exponent calculator block 214 receives the exponent bits of the first vector of binary numbers via a third set of input lines (Ae), and receives the exponent bits of the second vector of binary numbers via a fourth set of input lines (Be). The exponent of a product of two numbers with a same base equals the sum of the respective exponents of the two numbers. For example, (0.4×25)× (0.7×23)=(0.4×0.7)×28. Accordingly, the exponent calculator block 214 includes multiple exponent addition units. Each exponent addition unit adds an element of vector Ae to the corresponding element of vector Be, so that the result is the exponent for a corresponding element of vector C. Accordingly, the exponent calculator block 214 determines vector Ce. The exponent calculator block 214 provides vector Ce to the first exponent compare stage 216.

In the illustrated example, the first exponent compare stage 216 performs a pairwise comparison of eight elements, the second exponent compare stage 218 performs a pairwise comparison of four elements, and the third exponent compare stage 220 performs a pairwise comparison of two elements. Accordingly, the first exponent compare stage 216 includes four two-element comparators, the second exponent compare stage 218 includes two two-element comparators, and the third exponent compare stage 220 includes one two-element comparator. Each two-element comparator passes the larger of the two compared elements. Accordingly, the first, second, and third compare stages 216, 218, and 220 together determine the largest exponent in vector Ce.

The ones' complement block 222 receives vector Ce. The ones' complement block 222 includes multiple ones' complement units. Each ones' complement unit receives an element of vector Ce and provides the bitwise logical inverse of that element of vector Ce to the shift calculator block 224. In some examples (for some binary number representation types), adding a ones' complement of a first number to a second number is equivalent to subtracting the first number from the second number.

In some examples, the shift calculator block 224 performs two's complement subtraction. The shift calculator block 224 receives the largest element of vector Ce from the third exponent compare stage 220, and receives the ones' complement of vector Ce from the ones' complement block 222. The shift calculator block 224 adds the largest element of vector Ce to each element of the ones' complement of vector Ce, plus one, to generate a vector SHIFT. This is equivalent to subtracting each element of vector Ce from the largest element of vector Ce. The added one is used to complete the two's complement subtraction. In some examples, the added one is implemented as a carry-in input to a carry-propagate adder.

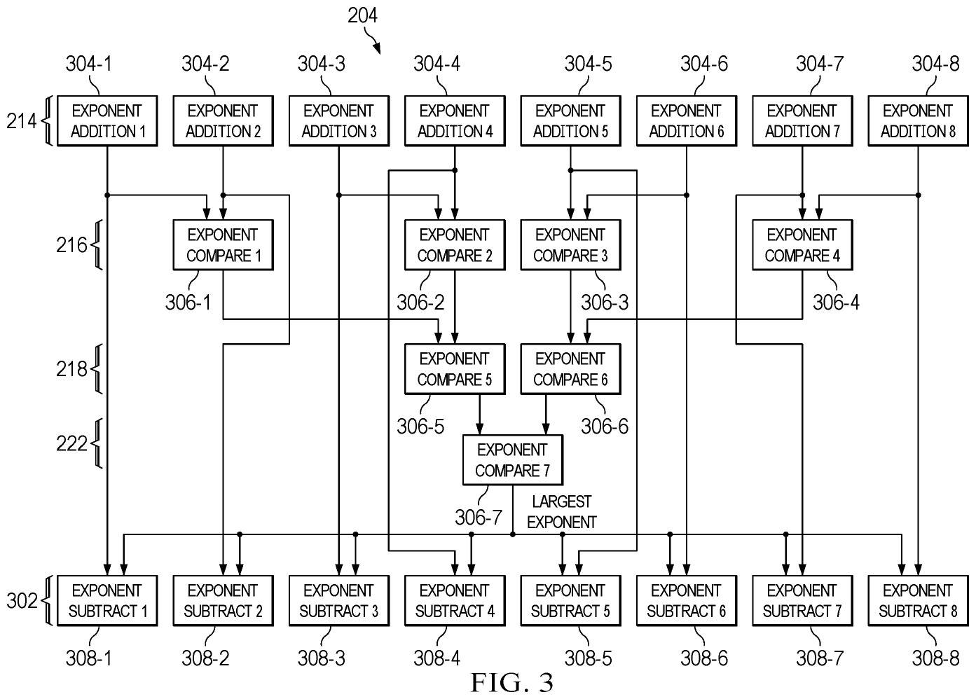

The exponent arithmetic unit is further described with respect to FIG. 3. Note that the element of SHIFT corresponding to the element of Ce indicating the largest exponent (corresponding to the output of the third exponent compare stage 220) equals zero, indicating that the corresponding element of Cm is to be shifted to the right by zero. Accordingly, a subset of the elements of Cm are shifted to the right by a non-zero number of bit positions. In some examples, processing by the exponent arithmetic unit 204 is performed in parallel with processing by the floating point vector multiplier 202.

In some examples, processing by the floating point adder 206 of an output vector C (corresponding to vectors Cm and Ce) of the floating point vector multiplier 202 waits until processing of the input vectors A and B has been completed by both the floating point vector multiplier 202 and the exponent arithmetic unit 204.

The alignment block 226 includes multiple alignment units. Each alignment unit shifts a corresponding element of vector Cm to the right by a number of bits specified by a corresponding element of vector SHIFT. This makes corresponding bits of different numbers in Cm have the same significance.

In some examples, the alignment block 226 truncates the elements of Cm. In an example, elements of Am and Bm have 24 bits, elements of Cm as output by the adder 212 have 48 bits, and the alignment block 226 truncates 16 LSBs of each of the elements of Cm to provide mantissas with 32 bits to the compressor 228.

In some examples, if the floating point sign of an element of Cm is negative, the alignment block 226 replaces that element with its two's complement. This enables an addition process performed by the compressor 228 and the adder 230 to be performed responsive to the signs of respective elements of Cm. In some examples, this conditional two's complement process is performed prior to or after alignment by the alignment block 226. In some examples, this conditional two's complement process is performed during or after addition by the adder 212 (or elsewhere). In some examples, the two's complement is performed piecemeal, such as by performing a ones' complement and introducing an additional plus-one later in a corresponding data path.

Note that bit shifting is distinct from zero padding. To perform bit shifting, ones and zeroes are shifted to the right (or left) as an exponent corresponding to a respective position within the expression of the mantissa changes and the format of the mantissa remains constant. Zeroes or ones, responsive to whether the element is positive or negative, are padded on the left (or right, for leftward shifts), and bits that are shifted out of the constant-size format are truncated on the right (or left, for leftward shifts). In some examples, positive numbers are padded with zeroes, and negative numbers are padded with ones. To perform zero padding, padding zeroes are added at a most significant bit position or at a least significant bit position so that the number of bits represented in the mantissa is increased by the padding zeroes.

In an example of alignment using bit shifting, elements in Cm have eight bits, and after alignment, a one in the fourth most significant bit (MSB) of Cm[1] would represent 2-8, as would a one in the fourth MSB of Cm[2], a one in the fourth MSB of Cm[3], etc. In this same example, a one in the MSB of Cm[1] would represent 2-5, as would a one in the MSB of Cm[2], a one in the MSB of Cm[3], etc. Note that the element of Cm with a same index j as the element of Ce corresponding to the number in C with the largest exponent (as determined by the exponent arithmetic unit 204) is shifted by zero bits. Accordingly, if Ce[j] indicates a number in C with a largest exponent (where j is an integer), then the alignment block shifts Cm[j] by zero bits. The alignment block 226 provides the aligned (bit shifted) elements of Cm to the compressor 228.

In some examples, bit shifting by the alignment block 226 may result in loss of precision as one or more binary ones are shifted to the right of a least significant bit (LSB) position of a corresponding element of Cm. In some examples, this loss of precision corresponds to less than or equal to one LSB in a final output of the MMA acceleration pipeline 104a.

The compressor 228 manipulates the N (for example, eight) aligned elements of Cm to provide two output numbers to the adder 230, so that the output numbers, when summed, correspond to the sum of the N aligned elements. Compressors are sometimes described as [number of inputs]:[number of outputs] compressors. Accordingly, the compressor 228 is an N:2 compressor. For example, if N equals eight, the compressor 228 is an 8:2 compressor. In some examples, the numbers output by the compressor 228 do not separately correspond to sums of the numbers input to the compressor 228. In some examples, the compressor 228 is a carry-save adder tree, and accordingly, includes multiple stages, with individual stages of the carry-save adder tree having multiple carry-save adders.

In some examples, adding together N numbers each with a number M binary digits is enabled by N/2 compressors, where the compressors are (M plus log₂N)-bit (or longer) 4:2 compressors. Accordingly, the compressors provide results that are M plus log₂N bits wide. For example, where N equals eight and the elements of the A and B input vectors are of type bfloat16, the 8:2 compressor 228 may be constructed from four 32-bit 4:2 compressors.

The adder 230 adds the two numbers provided by the compressor 228 to generate the sum of the N aligned elements of Cm. This sum, combined with the largest exponent in Ce as determined by the exponent arithmetic unit 204, corresponds to the dot product of vectors A and B. In some examples, the adder 230 is or includes a carry-propagate adder stage. In some examples, if the output of the carry-propagate adder stage is a negative number, an inverse (such as a two's complement) of that output is provided as the final result, and the sign bit of the final result is set accordingly. In some examples, this two's complement (or other inversion) is applied during or after normalization by the normalizer 232.

In some examples, each adder stage receives a first number of inputs each with a second number of bits, and provides a third number of outputs each with a fourth number of bits. In some examples, the fourth number equals the second number plus one. In some examples, adder stages correspond to (1) the first carry-save adder stage 402, (2) the second carry-save adder stage 404, (3) the carry-propagate adder stage 406, and (4) the adder 230. In some examples in which the compressor 228 receives 32 bit inputs, the adder 230 is a 35 bit wide adder that provides a 35 bit result. In some examples, the outputs of the compressor 228 cannot overflow during summation by the adder 230. Accordingly, in some examples, an MSB of a carry output of the compressor 228 and an MSB of a save output of the compressor 228 cannot both equal one (or both equal a zero indicating a negative one). In some examples, both outputs of a compressor 228 can have leading bits equal to (positive) one or (negative) zero, and the 35 bit wide adder can provide a 36 bit wide result.

In some examples, an exponent corresponding to the output of the adder 230 equals the largest element of Ce, adjusted responsive to a position of a leading bit of the output of the adder 230 relative to a position of the (aligned) leading bits of the inputs to the compressor 228. In some examples, a leading bit is a leading one for a positive number or a leading zero for a negative number.

In some examples, the result provided by the adder 230 has a larger bit width than a corresponding portion (such as a mantissa) of an output format that the MMA hardware accelerator 104 is designed or selected to provide (such as by the configuration registers 110). In some examples, the normalizer 232 shifts the result provided by the adder 230 towards its MSB (leftward) so that a leading bit is at the MSB of the corresponding portion of the output of the adder 230. The leftward shift applied by the normalizer 232 increases an effective precision of the output of the adder 230. In some examples, this can be described as retaining a maximum amount of available semantic content in the output of the adder 230.

Because a leftward shift increases the bit significance of corresponding shifted bits, the normalizer 232 decrements the exponent corresponding to the output of the adder 230 by one for each bit position by which the leading bit is shifted leftward. For example, if the normalizer 232 shifts the mantissa three bits to the left, the corresponding exponent is decremented by three.

The rounder 234 truncates LSBs of the corresponding portion of the output format in excess of the designed or selected bit width. In an example, the adder 230 provides a 35 bit result, but a mantissa of a float32 is specified by the IEEE 754 standard to include 23 bits. Accordingly, the normalizer 232 performs the described leftward shift, then the rounder 234 truncates 12 LSBs from the 35 bit mantissa to provide a mantissa field of the MMA acceleration pipeline 104 output vector. In some examples, the rounder 234 rounds the mantissa field prior to truncating. In some examples, rounding corresponds to a conditional incrementing by one of the mantissa field. In some examples, the rounder 234 truncates without rounding, which may be described as equivalent to unconditionally rounding to zero. In some examples, the rounder 234 rounds responsive to a rounding mode and a result of the normalization step.

In some examples, the output of the rounder 234 is the output of the MMA acceleration pipeline 104. In some examples, the output of the MMA acceleration pipeline 104 can also be described as an output vector.

In some examples, aligning mantissas of a set of binary fractions in response to a largest exponent of the binary fractions, and using a compressor and an adder to generate the sum of the aligned mantissas, may provide one or more benefits, including enabling addition of the binary fractions that is faster, uses less device area, and/or uses less power. In an example, disclosed methods enable 50% reductions in each of delay, device area, and power usage. In an example, a clock frequency of the IC 102 is one gigahertz (GHz) or more. In the example, a dot product between type bfloat16 elements of two eight-element vectors can be determined using two cycles for multiplication—and, in parallel, determination of the shift amount—and three cycles to generate the normalized sum of the resulting vector of products.

FIG. 2B is a functional block diagram of a second example hardware MMA acceleration pipeline 104b for a floating point MMA operation of FIG. 1. The MMA acceleration pipeline 104b is similar to the MMA acceleration pipeline 104a, but accepts a single input vector A, does not include a floating point vector multiplier 202, and the exponent arithmetic unit 204 does not include an exponent calculator block 214. In some examples, the MMA acceleration pipeline 104b uses the same (or some of the same) hardware as the MMA acceleration pipeline 104a, with configuration registers 110 storing settings that the control circuit 112 can use to cause the MMA acceleration pipeline 104b to accept and process a single input vector A, and to bypass the floating point vector multiplier 202 and the exponent calculator block 214. In some examples, bypass refers to the control circuit 112 causing a data flow to bypass the bypassed functional block(s).

As described above, the MMA acceleration pipeline 104b can be used to sum binary fraction elements of a vector A. In some examples, operation of the MMA acceleration pipeline 104b is the same as operation of the MMA acceleration pipeline 104a, except that: (1) the first exponent compare stage 216 of the MMA acceleration pipeline 104b receives a vector Ae that includes elements that are the exponent bits of elements of the single input vector A; and (2) the alignment block 226 of the MMA acceleration pipeline 104b receives a vector Am that includes elements that are the mantissa bits of elements of the single input vector A. Accordingly, the MMA acceleration pipeline 104b processes the input vector A similarly to processing by the MMA acceleration pipeline 104a once components of vector C (mantissa bit vector Cm and exponent bit vector Ce) have been determined.

FIG. 2C is a functional block diagram of a third example hardware MMA acceleration pipeline 104c for a floating point MMA operation of FIG. 1. The MMA acceleration pipeline 104c is similar to the MMA acceleration pipeline 104a, but it accepts vectors A and B with integer elements, does not include an exponent arithmetic unit 204, and the floating point adder 206 does not include an alignment block 226 or a normalizer 232. Accordingly, the MMA acceleration pipeline 104c includes an integer adder 236, which corresponds to the floating point adder 206 without the alignment block 226 or the normalizer 232.

Function of the MMA acceleration pipeline 104c is similar to function of the MMA acceleration pipeline 104a, except that the integer elements of the vector of products C do not include exponent bits, and are not aligned prior to summation by the integer adder 236. Accordingly, the MMA acceleration pipeline 104c can reuse hardware of the MMA acceleration pipeline 104a, with configuration registers 110 storing settings that the control circuit 112 can use to cause the MMA acceleration pipeline 104b to accept and process integer vectors, and to bypass the exponent arithmetic unit 204 and the alignment block 226. Reusing hardware used to determine a dot product of vectors of floating point binary numbers to determine a dot product of vectors of integers enables a reduction in device area cost for the MMA acceleration pipeline 104c.

FIG. 3 is a functional block diagram of an example hardware exponent arithmetic unit 204 of FIG. 2A. The exponent arithmetic unit 204 corresponds to an MMA acceleration pipeline 104a configured to process input vectors A and B that each include eight floating point elements. The exponent arithmetic unit 204 includes the exponent calculator block 214, the first exponent compare stage 216, the second exponent compare stage 218, the third exponent compare stage 220, the ones' complement block 222, and an exponent subtraction block 302. The exponent subtraction block 302 corresponds to (or incorporates) the ones' complement block 222 and the shift calculator block 224.

The exponent calculator block 214 includes a first exponent addition unit (exponent addition 1) 304-1, a second exponent addition unit (exponent addition 2) 304-2, a third exponent addition unit (exponent addition 3) 304-3, a fourth exponent addition unit (exponent addition 4) 304-4, a fifth exponent addition unit (exponent addition 5) 304-5, a sixth exponent addition unit (exponent addition 6) 304-6, a seventh exponent addition unit (exponent addition 7) 304-7, and an eighth exponent addition unit (exponent addition 8) 304-8.

The first exponent compare stage 216 includes a first exponent comparator 306-1 (exponent compare 1), a second exponent comparator 306-2 (exponent compare 2), a third exponent comparator 306-3 (exponent compare 3), and a fourth exponent comparator 306-4 (exponent compare 4). The second exponent compare stage 218 includes a fifth exponent comparator 306-5 (exponent compare 5) and a sixth exponent comparator 306-6 (exponent compare 6). The third exponent compare stage 220 includes a seventh exponent comparator 306-7 (exponent compare 7).

The exponent subtraction block 302 includes a first exponent subtraction unit (exponent subtract 1) 308-1, a second exponent subtraction unit (exponent subtract 2) 308-2, a third exponent subtraction unit (exponent subtract 3) 308-3, a fourth exponent subtraction unit (exponent subtract 4) 308-4, a fifth exponent subtraction unit (exponent subtract 5) 308-5, a sixth exponent subtraction unit (exponent subtract 6) 308-6, a seventh exponent subtraction unit (exponent subtract 7) 308-7, and an eighth exponent subtraction unit (exponent subtract 8) 308-8.

In an example, the first exponent addition unit 304-1 receives Ae[1] and Be[1] as inputs. The second exponent addition unit 304-2 receives Ae[2] and Be[2] as inputs. The third exponent addition unit 304-3 receives Ae[3] and Be[3] as inputs. The fourth exponent addition unit 304-4 receives Ae[4] and Be[4] as inputs. The fifth exponent addition unit 304-5 receives Ae[5] and Be[5] as inputs. The sixth exponent addition unit 304-6 receives Ae[6] and Be[6] as inputs. The seventh exponent addition unit 304-7 receives Ae[7] and Be[7] as inputs. And the eighth exponent addition unit 304-8 receives Ae[8] and Be[8] as inputs.

The first exponent addition unit 304-1 outputs to the first exponent comparator 306-1 and to the first exponent subtraction unit 308-1. The second exponent addition unit 304-2 outputs to the first exponent comparator 306-1 and to the second exponent subtraction unit 308-2. The third exponent addition unit 304-3 outputs to the second exponent comparator 306-2 and to the third exponent subtraction unit 308-3. The fourth exponent addition unit 304-4 outputs to the second exponent comparator 306-2 and to the fourth exponent subtraction unit 308-4. The fifth exponent addition unit 304-5 outputs to the third exponent comparator 306-3 and to the fifth exponent subtraction unit 308-5. The sixth exponent addition unit 304-6 outputs to the third exponent comparator 306-3 and to the sixth exponent subtraction unit 308-6. The seventh exponent addition unit 304-7 outputs to the fourth exponent comparator 306-4 and to the seventh exponent subtraction unit 308-7. And the eighth exponent addition unit 304-8 outputs to the fourth exponent comparator 306-4 and to the eighth exponent subtraction unit 308-8. Each exponent comparator 306 outputs the larger of the two exponents it receives as inputs.

The first and second exponent comparators 306-1 and 306-2 output to the fifth exponent comparator 306-5. The third and fourth exponent comparators 306-3 and 306-4 output to the sixth exponent comparator 306-6. The fifth and sixth exponent comparators 306-5 and 306-6 output to the seventh exponent comparator 306-7. The seventh exponent comparator 306-7 outputs to the first, second, third, fourth, fifth, sixth, and seventh exponent subtraction units 308-1, 308-2, 308-3, 308-4, 308-5, 308-6, 308-7, and 308-8. The output of the seventh exponent comparator 306-7 corresponds to the largest exponent (for example, element of Ae in a single vector case, or sum of respective elements of Ae and Be) from among the outputs of the exponent addition units 304. The outputs of the exponent subtraction units 308 are used by the alignment block 226 to determine the number of digits rightward to shift the mantissas of corresponding elements of the mantissa vector to align them to the mantissa of the binary fraction being summed that has the largest exponent.

FIG. 4A is a functional block diagram of a first example addition unit 400 that includes the compressor 228 and adder 230 of FIG. 2A. The compressor 228 includes a first carry-save adder stage 402 and a second carry-save adder stage 404. The adder 230 includes a carry-propagate adder stage 406. The first and second carry-save adder stages 402 and 404 each include multiple carry-save adders 408. The carry-propagate stage includes multiple carry-propagate adders 410. The first addition unit 400 is an example corresponding to an input vector with four elements, individual elements respectively including four bits. Some examples provided below correspond to vectors with more elements and/or more bits. Some example addition units, such as the addition unit 400 or the addition unit 426 (see FIGS. 4D and 4E), may be extended, such as with additional carry-save adders and/or carry-propagate adders, to enable addition of elements with more than four bits.

The first carry-save adder stage 402 includes a first carry-save adder 408-1, a second carry-save adder 408-2, a third carry-save adder 408-3, and a fourth carry-save adder 408-4. The second carry-save adder stage 404 includes a fifth carry-save adder 408-5, a sixth carry-save adder 408-6, a seventh carry-save adder 408-7, and an eighth carry-save adder 408-8. The carry-propagate adder stage 406 includes a first carry-propagate adder 410-1, a second carry-propagate adder 410-2, a third carry-propagate adder 410-3, and a fourth carry-propagate adder 410-4.

Each carry-save adder 408 receives three inputs, and processes those inputs to provide two outputs: a carry output and a save output. Carry outputs are referred to as [c-sub-number] and save outputs are referred to as [s-sub-number]. The addition unit 400 receives input numbers (for example, mantissas or integers) w, x, y, and z, with binary digits [vector name-sub-bit significance index number]. In an example, input numbers w, x, y, and z, correspond to aligned elements of vector Cm (accordingly, output of the alignment block 226), for example, Cm[0], Cm[1], Cm[2], and Cm[3] (or in an example in which a vector includes eight elements, as in FIG. 2A, Cm[0], Cm[1], Cm[2], . . . , Cm[8]).

In the first carry-save adder stage 402, the first carry-save adder 408-1 receives x₀, y₀, and z₀, and outputs s₀ and c₁. The second carry-save adder 408-2 receives x₁, y₁, and z₁, and outputs s₁ and c₂. The third carry-save adder 408-3 receives x₂, y₂, and z₂, and outputs s₂ and c₃. And the fourth carry-save adder 408-4 receives x₃, y₃, and z₃, and outputs s₃ and c₄.

In the second carry-save adder stage 404, the fifth carry-save adder 408-5 receives so and w₀, and outputs s₀′ (read s-sub-zero prime) and c₁′. The sixth carry-save adder 408-6 receives c₁, s₁, and w₁, and outputs s₁′ and c₂′. The seventh carry-save adder 408-7 receives c₂, s₂, and w₂, and outputs s₂′ and c₃′. And the eighth carry-save adder 408-8 receives c₃, s₃, and w₃, and outputs s₃′ and c₄′.

As described, the first and second carry-save adder stages 402 and 404 each accept three inputs and provide two outputs. The first carry-save adder stage 402 receives inputs corresponding to numbers x, y, and z, and generates outputs corresponding to carry vector c with elements c₁, c₂, c₃, and c₄, and save vector s with elements s₀, s₁, s₂, and s₃. The second carry-save adder stage 404 receives inputs corresponding to number w with elements w₀, w₁, w₂, and w₃ and vectors c and s, and generates outputs corresponding to carry vector c′ with elements c₁′, c₂′, c₃′, and c₄′, and save vector s′ with elements s₀′, s₁′, s₂′, and s₃′. Accordingly, the first and second carry-save adder stages 402 and 404 are each 3:2 compressors.

As described, the compressor 228 accepts four inputs corresponding to numbers w, x, y, and z, and generates two outputs corresponding to carry vector c′ and save vector s′. Accordingly, the compressor 228, as shown in and described with respect to the addition unit 400, is a 4:2 compressor.

In the carry-propagate adder stage 406, the first carry-propagate adder 410-1 receives c₁′ and s₁′ and outputs S₁ and c₂″ (read c-sub-two double prime). The second carry-propagate adder 410-2 receives c₂″, c₂′, and s₂′ and outputs S₂ and c₃″. The third carry-propagate adder 410-3 receives c₃″, c₃′, and s₃′ and outputs S₃ and c₄″. And the fourth carry-propagate adder 410-4 receives c₄″, c₄′, and c₄ and outputs S₄ and S₅.

The outputs of the addition unit 400 are S₀, which corresponds to so′ (from the fifth carry-save adder 408-5), along with S₁, S₂, S₃, S₄, and S₅. Together, these save bits represent a binary number of form S₅S₄S₃S₂S₁S₀ (written from MSB on the left to LSB on the right) that is the sum of input numbers w, x, y, and z. For example, if S₅, S₃, and S₁ equal one and S₄, S₂, and S₀ equal zero, then the output of the addition unit 400 is 101010.

FIG. 4B is an alternative functional block diagram of the addition unit 400 of FIG. 4A. In FIG. 4B, the addition unit 400 is shown at a stage level. The first carry-save adder stage 402 receives input numbers x, y, and z, and outputs a carry vector c and a save vector s. In an example corresponding to the addition unit 400 as shown in FIG. 4A, carry vector c includes elements c₁, c₂, c₃, and c₄ and save vector s includes elements s₀, s₁, s₂, and s₃. The second carry-save adder stage 404 receives input vectors c and s and input number w, and outputs a carry vector c′ and a save vector s′. The carry-propagate adder stage 406 receives input vectors c′ and s′, and outputs vector S. Vector S is the output of the addition unit 400. In the example corresponding to the addition unit 400 as shown in FIG. 4A, vector S includes elements S₀, S₁, S₂, S₃, S₄, and S₅.

FIG. 4C is a functional block diagram of a second example addition unit 412 that includes the compressor 228 and adder 230 of FIG. 2A. The addition unit 412 includes a first carry-save adder stage 414, a second carry-save adder stage 416, a third carry-save adder stage 418, a fourth carry-save adder stage 420, a fifth carry-save adder stage 422, and a carry-propagate adder 424. The compressor 228 includes the carry-save adder stages 414, 416, 418, 420, and 422, and the adder 230 includes the carry-propagate adder 424.

Each of the carry-save adder stages 414, 416, 418, 420, and 422 is a 3:2 compressor, similar to the first and second carry-save adder stages 402 and 404 of the addition unit 400 of FIG. 4A. The addition unit 412 accepts a seven element vector C (C[0], . . . , C[6]) as input and provides a carry vector and a save vector as output. Accordingly, the addition unit 412 provides two outputs in response to seven inputs, so that the addition unit 412 is a 7:2 compressor.

The outputs of each carry-save adder stage 414, 416, 418, 420, and 422 include a carry vector and a save vector. The first carry-save adder stage 414 receives input numbers C[0], C[1], and C[2]. A first output of the first carry-save adder stage 414 is connected to a first input of the fourth carry-save adder stage 420, and a second output of the first carry-save adder stage 414 is connected to a first input of the third carry-save adder stage 418.

The second carry-save adder stage 416 receives input numbers C[3], C[4], and C[5]. First and second outputs of the second carry-save adder stage 416 are connected to second and third inputs of the third carry-save adder stage 418. A second input of the fourth carry-save adder stage 420 receives input number C[6]. A first output of the third carry-save adder stage 418 is connected to a third input of the fourth carry-save adder stage 420, and a second output of the third carry-save adder stage 418 is connected to a first input of the fifth carry-save adder stage 422. First and second outputs of the fourth carry-save adder stage 420 are connected to second and third inputs of the fifth carry-save adder stage 422.

The first and second outputs of the fifth carry-save adder stage 422 are connected to the first and second inputs of the carry-propagate adder 424. The carry-propagate adder 424 provides the output of the addition unit 412.

FIG. 4D is a functional block diagram of a third example addition unit 426a that includes the compressor 228 and adder 230 of FIG. 2A. FIG. 4E is a continuation 226b of the functional block diagram of the third example addition unit 226a of FIG. 4D. Accordingly, FIGS. 4D and 4E together show the third example addition unit 226. The compressor 228 includes a first carry-save adder stage 428, a second carry-save adder stage 430, a third carry-save adder stage 432, a fourth carry-save adder stage 434, a fifth carry-save adder stage 436, and a sixth carry-save adder stage 438. The adder 230 includes a carry-propagate adder stage 440. The first, second, third, fourth, fifth, and sixth carry-save adder stages 428, 430, 432, 434, 436, and 438 each include multiple carry-save adders 442. The carry-propagate adder stage 440 includes multiple carry-propagate adders 444.

In FIG. 4D, the first carry-save adder stage 428 includes a first carry-save adder 442-1, a second carry-save adder 442-2, a third carry-save adder 442-3, and a fourth carry-save adder 442-4. The second carry-save adder stage 430 includes a fifth carry-save adder 442-5, a sixth carry-save adder 442-6, a seventh carry-save adder 442-7, and an eighth carry-save adder 442-8. The third carry-save adder stage 432 includes a ninth carry-save adder 442-9, a tenth carry-save adder 442-10, a eleventh carry-save adder 442-11, and a twelfth carry-save adder 442-12. The fourth carry-save adder stage 434 includes a thirteenth carry-save adder 442-13, a fourteenth carry-save adder 442-14, a fifteenth carry-save adder 442-15, and a sixteenth carry-save adder 442-16.

In. FIG. 4E, the fifth carry-save adder stage 436 includes a seventeenth carry-save adder 442-17, an eighteenth carry-save adder 442-18, a nineteenth carry-save adder 442-19, a twentieth carry-save adder 442-4, and a twenty-first carry-save adder 442-21. The sixth carry-save adder stage 438 includes a twenty-second carry-save adder 442-2, a twenty-third carry-save adder 442-23, a twenty-fourth carry-save adder 442-24, and a twenty-fifth carry-save adder 442-25. The carry-propagate adder stage 440 includes a first carry-propagate adder 444-1, a second carry-propagate adder 444-2, a third carry-propagate adder 444-3, and a fourth carry-propagate adder 444-4.

The addition unit 400 receives input numbers (for example, mantissas or integers) d, c, f, g, h, i, j, and k with binary digits [vector name-sub-bit significance index number]. As described with respect to the carry-save adders 408 of FIG. 4A, each carry-save adder 442 receives three inputs, and processes those inputs to provide two outputs: a carry output and a save output. Outputs of the first and third carry-save adder stages 228 and 232 receive an “a” subscript to indicate correspondence to input numbers d, e, f, and g. Outputs of the second and fourth carry-save adder stages 230 and 234 receive a “b” subscript to indicate correspondence to input numbers h, i, j, and k. And outputs of the fifth and sixth carry-save adder stages 236 and 238 receive a “c” subscript to indicate correspondence to input numbers d, e, f, g, h, i, j, and k (sums of bits corresponding to each received input number). Accordingly, carry outputs are referred to as [c-sub-number-a, b, or c] and save outputs are referred to as [s-sub-number-a, b, or c]. In an example, input numbers d, e, f, g, h, i, j, and k, correspond to aligned elements of vector Cm.

In FIG. 4D, in the first carry-save adder stage 428, the first carry-save adder 442-1 receives d₀, e₀, and f₀, and outputs s₀ₐ and c₁ₐ. The second carry-save adder 442-2 receives d₁, e₁, and f₁, and outputs s₁ₐ and c₂ₐ. The third carry-save adder 442-3 receives d₂, e₂, and f₂, and outputs s₂ₐ and c₃ₐ. And the fourth carry-save adder 442-4 receives d₃, e₃, and f₃, and outputs s₃ₐ and c₄ₐ.

In the second carry-save adder stage 430, the fifth carry-save adder 442-5 receives h₀, i₀, and j₀, and outputs s_{0b} and c_{1b}. The sixth carry-save adder 442-6 receives h₁, i₁, and j₁, and outputs s_{1b} and c_{2b}. The seventh carry-save adder 442-7 receives h₂, i₂, and j₂, and outputs s_{2b} and c_{3b}. And the eighth carry-save adder 442-8 receives h₃, i₃, and j₃, and outputs s_{3b} and c_{4b}.

In the third carry-save adder stage 432, the ninth carry-save adder 442-9 receives s₀ₐ and g₀, and outputs s₀ₐ′ and c₁ₐ′. The tenth carry-save adder 442-10 receives c₁ₐ, s₁ₐ, and g₁, and outputs s₁ₐ′ and c₂ₐ′. The eleventh carry-save adder 442-11 receives c₂ₐ, s₂ₐ, and g₂, and outputs s₂ₐ′ and c₃ₐ′. And the twelfth carry-save adder 442-12 receives c₃ₐ, s₃ₐ, and g₃, and outputs s₃ₐ′ and c₄ₐ′.

In the fourth carry-save adder stage 434, the thirteenth carry-save adder 442-13 receives s_{0b} and k₀, and outputs s_{0b}′ and c_{1b}′. The fourteenth carry-save adder 442-14 receives c_{1b}, s_{1b}, and k₁, and outputs s_{1b}′ and c_{2b}′. The fifteenth carry-save adder 442-15 receives c_{2b}, s_{2b}, and k₂, and outputs s_{2b}′ and c_{3b}′. And the sixteenth carry-save adder 442-16 receives c_{3b}, s_{3b}, and k₃, and outputs s_{3b}′ and c_{4b}′.

In FIG. 4E, in the fifth carry-save adder stage 436, the seventeenth carry-save adder 442-17 receives s₀ₐ′ and s_{0b}′, and outputs S₀ (s_{0c}) and c_{0c}. (Similarly to the first addition unit 400 of FIG. 4A, capital-S save bits are output bits of the third addition unit 426.) The eighteenth carry-save adder 442-18 receives s₁ₐ′, s_{1b}′, and c₁ₐ′, and outputs s_{1c} and c_{2c}. The nineteenth carry-save adder 442-19 receives s₂ₐ′, s_{2b}′, and c₂ₐ′, and outputs s_{2c} and c_{3c}. The twentieth carry-save adder 442-20 receives s₃ₐ′, s_{3b}′, and c₃ₐ′, and outputs s_{3c} and c_{4c}. The twenty-first carry-save adder 442-21 receives c₄ₐ, c_{4b}, and c₄ₐ′, and outputs s_{4c} and c_{5c}.

In the sixth carry-save adder stage 438, the twenty-second carry-save adder 442-22 receives c_{1c}, s_{1c}, and c_{1b}′, and outputs S₁ (s_{1c}′) and c_{2c}′. The twenty-third carry-save adder 442-23 receives c_{2c}, s_{2c}, and c_{2b}′, and outputs s_{2c}′ and c_{3c}′. The twenty-fourth carry-save adder 442-24 receives c_{3c}, s_{3c}, and c_{3b}′, and outputs s_{3c}′ and c_{4c}′. The twenty-fifth carry-save adder 442-25 receives c_{4c}, s_{4c}, and c_{4b}′, and outputs s_{4c}′ and c_{5c}′.

In the carry-propagate stage 440, the first carry-propagate adder 444-1 receives c_{2c}′ and s_{2c}′, and outputs S₂ and c_{3c}″. The second carry-propagate adder 444-2 receives c_{3c}″, c_{3c}′ and s_{3c}′, and outputs S₃ and c_{4c}″. The third carry-propagate adder 444-3 receives c_{4c}″, c_{4c}′ and s_{4c}′, and outputs S₄ and c_{5c}″. And the fourth carry-propagate adder 444-4 receives c_{5c}″, c_{5c}′ and c_{5c}, and outputs S₅ and S₆. Accordingly, the outputs of the third addition unit 426 are S₀, S₁, S₂, S₃, S₄, S₅, and S₆, which together can be read, from MSB on the left to LSB on the right, as S₆S₅S₄S₃S₂S₁S₀, corresponding to the sum of input numbers d, e, f, g, h, i, j, and k.

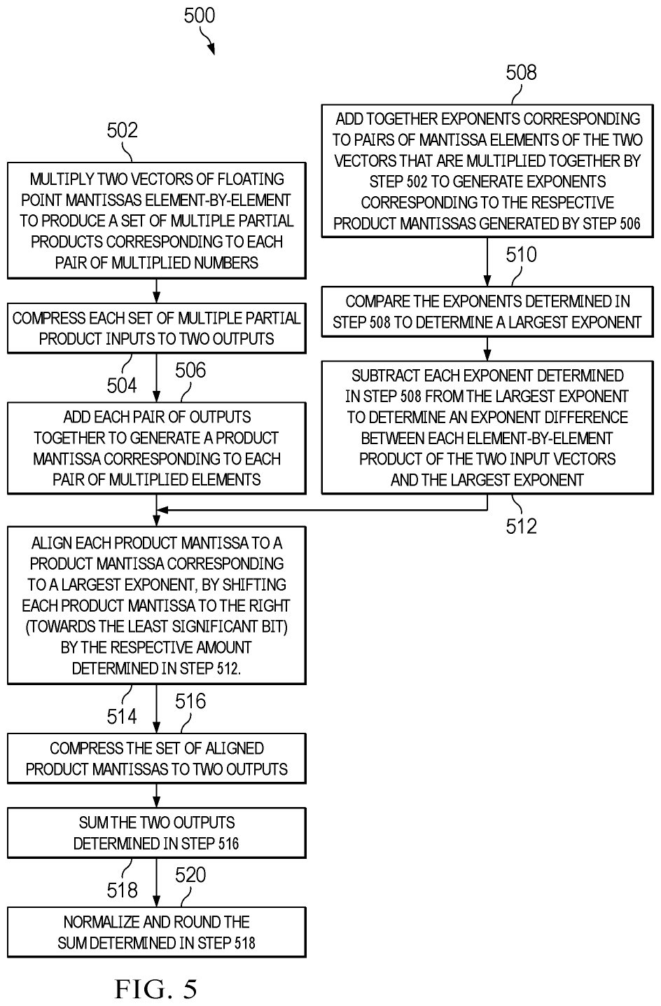

FIG. 5 is a process 500 for determining a dot product between the elements of two vectors of floating point binary numbers. In step 502, multiply two vectors of floating point mantissas element-by-element to produce a set of multiple partial products corresponding to each pair of multiplied numbers. In step 504, compress each set of multiple partial product inputs to two outputs. In step 506, add each pair of outputs together to generate a product mantissa corresponding to each pair of multiplied elements.

Steps 508 through 512 are performed in parallel with steps 502 through 506. In step 508, add together exponents corresponding to pairs of mantissa elements of the two vectors that are multiplied together by step 502 to generate exponents corresponding to the respective product mantissas generated by step 506. In step 510, compare the exponents determined in step 508 to determine a largest exponent. In step 512, subtract each exponent determined in step 508 from the largest exponent to determine an exponent difference between each element-by-element product of the two input vectors and the largest exponent.

In step 514, align each product mantissa to a product mantissa corresponding to a largest exponent, by shifting each product mantissa to the right (towards the least significant bit) by the respective amount determined in step 512. In step 516, compress the set of aligned product mantissas to two outputs. In step 518, sum the two outputs determined in step 516. And in step 520, normalize and round the sum determined in step 518.

Modifications are possible in the described examples, and other examples are possible within the scope of the claims.

In some examples, an MMA acceleration pipeline 104 is implemented using software, or using a combination of hardware and software.

In some examples, configuration registers store settlings enabling an MMA acceleration pipeline 104a to be used with a different configuration or with other functionality than described herein.

In some examples, the floating point vector multiplier 202 and/or the floating point adder 206 process binary data values other than binary floating point mantissas.

In some examples, memory other than configuration registers 110, or another mechanism, is used to store settings enabling an MMA acceleration pipeline 104a to be used as an MMA acceleration pipeline 104b, an MMA acceleration pipeline 104c, or in another configuration or with other functionality.

In some examples, functional blocks of the floating point vector multiplier 202, the exponent arithmetic unit 204, or the floating point adder 206 include different numbers of component blocks processing, for example, elements or pairs of elements, than shown herewith or described herein.

In some examples, doubling the number of elements in each input vector (corresponding to doubling the number of numbers to be added together by the floating point adder 206) is enabled by adding an additional exponent compare stage to the exponent arithmetic unit 204, and by adding a carry-save adder stage (or comparable compression stage) to the compressor 228.

In some examples, a bit width is used at the alignment block 226 sufficient to prevent or reduce a loss in precision caused by shifting of mantissas.

In some examples, outputs of a compressor are referred to as compressed values.

In some examples, an 8:2 compression stage for eight M-bit numbers (M is an integer) is implemented using six times M full adders.

In some examples, an exponent compare stage (such as the first exponent compare stage 216) is implemented using a nine or ten bit adder, or a nine or ten bit comparator. In some examples, a bit depth used by an exponent compare stage is responsive to when in the SHIFT determination process a debiasing computation is performed.

In some examples, zero padding is used to align mantissas (or other values). In some examples, a combination of zero padding and truncation is used to align values.

In some examples, a compressor is implemented using adders or other logic other than described above, such as half adders, full adders, skip adders, or carry-lookahead adders.

In some examples, a compressor and/or an adder is implemented using different arrangements of adder blocks and/or different types of adder blocks or other arithmetic or other logic blocks than shown herein. In some examples, a compressor and/or an adder (or other block(s)) processes different numbers of input numbers and/or different bit width numbers than described herein.

In some examples, sets of numbers to be added and/or multiplied are organized otherwise than in vectors. In some examples, a vector corresponds to a linked list or an array.

The term “couple” is used throughout the specification. The term may cover connections, communications, or signal paths that enable a functional relationship consistent with this description. For example, if device A provides a signal to control device B to perform an action, in a first example device A is coupled to device B, or in a second example device A is coupled to device B through intervening component C if intervening component C does not substantially alter the functional relationship between device A and device B such that device B is controlled by device A via the control signal provided by device A.

In this description, the term “and/or” (when used in a form such as A, B and/or C) refers to any combination or subset of A, B, C, such as: (a) A alone; (b) B alone; (c) C alone; (d) A with B; (e) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin”, “ball” and “lead” are used interchangeably. Unless specifically stated to the contrary, these terms are generally used to mean an interconnection between or a terminus of a device element, a circuit element, an integrated circuit, a device or other electronics or semiconductor component.

While certain elements of the described examples may be included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

What is claimed is:

1. An integrated circuit (IC), comprising:
a comparator circuit configured to receive a first number of exponents and to determine a largest exponent of the exponents;
a shift calculator configured to receive the exponents and the largest exponent, and to subtract each of the exponents from the largest exponent to provide a set of shift values;
an aligner circuit configured to receive a first number of data values and the set of shift values, and to shift a subset of the data values in a least significant bit direction responsive to respective ones of the shift values to generate a first number of aligned data values;
a compressor circuit configured to receive the aligned data values, and to generate a second number of compressed data values responsive to the first number of aligned data values, wherein the second number is less than the first number; and
an adder circuit configured to sum the compressed data values.

2. The IC of claim 1,
wherein the data values are third data values;
further comprising a vector multiplier circuit configured to receive a first number of first data values and a first number of second data values, and to multiply ones of the first number of first data values by corresponding ones of the second data values to generate the third data values.

3. The IC of claim 2, wherein the compressor circuit is a first compressor circuit and the adder circuit is a first adder circuit, wherein the aligner has an input configured to receive the third data values, and wherein the vector multiplier circuit includes:
a multiplication block having a first input configured to receive the first data values, a second input configured to receive the second data values, and an output;
a second compressor circuit having an input and an output, the input of the compressor coupled to the output of the multiplication block; and
an second adder circuit having an input and an output, the input of the adder coupled to the output of the compressor, and the output of the adder coupled to the input of the aligner.

4. The IC of claim 2,
wherein the first, second, and third data values are mantissas, and the exponents are third exponents;
further comprising an exponent calculator configured to receive a first number of first exponents corresponding to the first data values and a first number of second exponents corresponding to the second data values, and to add ones of the first exponents to corresponding ones of the second exponents to generate the third exponents.

5. The IC of claim 2, further comprising:
multiple configuration registers; and
a control circuit configured to cause a data flow to bypass one or more of the multiplier, the comparator, the shift calculator, or the aligner.

6. The IC of claim 1, wherein the second number equals two.

7. The IC of claim 1,
wherein the adder provides a provisional result responsive to summing the compressed data values;
the IC further comprising a normalizer configured to receive the provisional result, shift a leading bit of the provisional result towards a most significant bit position of the provisional result, and decrement an exponent corresponding to the provisional result responsive to the shifting of the leading bit.

8. The IC of claim 1, wherein a data value corresponding to the largest exponent is shifted by zero bits by the aligner.

9. A system comprising:
a comparator;
a shift calculator;
an aligner;
a compressor;
an adder;
a non-transitory memory configured to store an instruction and a set of data values; and
a processor configured to receive the instruction from the memory and to, in response to the instruction, cause:
the comparator to receive a first number of exponents and to determine a largest exponent of the exponents;
the shift calculator to receive the exponents and the largest exponent, and to subtract the exponents from the largest exponent to provide a set of shift values;
the aligner to receive a first number of data values and the set of shift values, and to shift a subset of the data values in a least significant bit direction responsive to respective ones of the shift values to generate a first number of aligned data values;
the compressor to receive the aligned data values, and to generate a second number of compressed data values responsive to the first number of aligned data values, wherein the second number is less than the first number; and
the adder to sum the compressed data values.

10. The system of claim 9,
wherein the data values are third data values;
the system further comprising a multiplier; and
wherein the processor is configured to, in response to the instruction, cause the multiplier to receive a first number of first data values and a first number of second data values, and to multiply ones of the first number of first data values by corresponding ones of the second data values to generate the third data values.

11. The system of claim 10, wherein the aligner has an input configured to receive the third data values, and wherein the multiplier includes:
a multiplication block having a first input configured to receive the first data values, a second input configured to receive the second data values, and an output;
a second compressor having an input and an output, the input of the compressor coupled to the output of the multiplication block; and
a second adder having an input and an output, the input of the adder coupled to the output of the compressor, and the output of the adder coupled to the input of the aligner.

12. The system of claim 10,
wherein the first, second, and third data values are mantissas, and the exponents are third exponents;
the system further comprising an exponent calculator;
wherein the processor is configured to, in response to the instruction, cause the exponent calculator to receive a first number of first exponents corresponding to the first data values and a first number of second exponents corresponding to the second data values, and to add ones of the first exponents to corresponding ones of the second exponents to generate the third exponents.

13. The system of claim 10, further comprising:
multiple configuration registers; and
a control circuit configured to cause a data flow to bypass one or more of the multiplier, the comparator, the shift calculator, or the aligner.

14. The system of claim 9, wherein the second number equals two.

15. The system of claim 9,
wherein the adder provides a provisional result responsive to summing the compressed data values;
the system further comprising a normalizer configured to receive the provisional result, shift a leading bit of the provisional result towards a most significant bit position of the provisional result, and decrement an exponent corresponding to the provisional result responsive to the shifting of the leading bit.

16. The system of claim 9, wherein a data value corresponding to the largest exponent is shifted by zero bits by the aligner.

17. A method comprising:
comparing a first number of exponents to determine a largest exponent of the exponents;
determining a set of shift values in response to the exponents and the largest exponent;
aligning a subset of a first number of data values by shifting the data values in a least significant bit direction, responsive to respective ones of the shift values, to generate a first number of aligned data values;
compressing the aligned data values, responsive to the first number of aligned data values, to generate a second number of compressed data values; and
summing the compressed data values.

18. The method of claim 17,
wherein the data values are third data values; and
the method further comprising multiplying a first number of first data values by corresponding ones of a first number of second data values to generate the third data values.

19. The method of claim 18, further comprising bypassing, as a data flow, and responsive to one or more configuration registers, one or more of the multiplying, the comparing, the determining, or the aligning.

20. The method of claim 17, wherein a data value corresponding to the largest exponent is shifted by zero bits by the aligning.
